(19) United States
(12) Patent Application Publication
(10) Pub. No.: US 2015/0100474 A1
(43) Pub. Date: Apr. 9, 2015

(54) INTERNET ROSCA DATA PROCESSING METHOD

(71) Applicant: SHACOM. COM INC., Taipei City (TW)

(72) Inventors: Ying-Jiun SHIH, Taipei City (TW); Cheng CHIEN, Taipei City (TW)

(21) Appl. No.: 14/502,271

(22) Filed: Sep. 30, 2014

(30) Foreign Application Priority Data
Oct. 3, 2013 (TW) 102135880

(51) Int. Cl. G06Q 40/02

(52) U.S. Cl. CPC G06Q 40/025
USPC 705/38

(57) ABSTRACT

An Internet Rosca data processing method, including the following steps executed by a server: (A) receiving a plurality of first instructions transmitted by a plurality of user terminals so that a plurality of members are added into a Rosca set that includes a plurality of Rosca groups; (B) classifying the plurality of members as loan benchmark members and investment benchmark members according to the plurality of first instructions, account information of the plurality of members stored in a storage module, and winning bid information and bidding information in the first Rosca group of the Rosca set that are stored in the storage module; and (C) adding the loan benchmark members and the investment benchmark members into a second Rosca group according to a predetermined percentage to obtain all members of the second Rosca group.

### PRIORITY

This application claims priority to Taiwan Patent Application No. 102135880 filed on Oct. 3, 2014, which is hereby incorporated by reference in its entirety.

### FIELD

The present invention relates to the field of electronic commerce (e-commerce), and particularly, to an Internet Rosca data processing method.

### BACKGROUND

Since the advent of the Internet, the financial sector has been making attempts to provide a banking system that can reflect the network form, and such a banking system is known as the “future bank”. However, so far, application of the network technologies in the financial sector is only limited to electronization of internal operations of the conventional banks, and the whole banking system still operates on the basis of closed operation concepts. Therefore, only the general operation efficiency of the banks gets improved, and there is still a long way to go to really achieve highly efficient network finance. Also for this reason, an open network direct financial operation system has become a way to achieve the development target of the modern bank.

In the operation mode of the conventional bank, investing credits of clients in advance is still used as the primary means to control credit risks. This practice totally relies on the credit rating (joint credit investigation) and collaterals as the means to evaluate the client credit risks. This operation mode has the following disadvantage: in periods when the financial situations are stable, some clients might be rejected because of the incomplete credit rating system or because the clients cannot provide adequate collaterals; and in case of a financial turbulence, a chain financial disaster might be caused due to deficiencies of the risk evaluation system, which can be evidenced the best by the financial tsunami that occurred in the last few years.

To solve the difficult problems confronted currently by the financial sector, networks named such as ZOPA and Prosper that deal with the network direct finance have been established in Britain and the United States respectively since 2006, which allow the debtor and the creditor to directly communicate via the network to reduce the dependence of the clients on the indirect finance and improve the fund transaction efficiency. Although these networks have the embryonic form of the network direct finance, they still cannot provide guarantees against breach of the clients, and selection of the clients still completely relies on the credit evaluation system. Consequently, such a form cannot be implemented at a large scale in the market to contribute to the efficiency of the overall financial market.

The Bank SinoPac has established an MMA Rosca financial transaction network in 2008, which is a network direct finance innovative solution that is proposed on the basis of the Taiwan Rosca. Because the Rosca has the natures of savings and credits integrated together, the direct finance efficiency thereof is higher than the two networks ZOPA and Prosper. However, whether the Rosca is successful depends on how to allow people who have a demand for funds to obtain the funds at a low interest rate and allow people who want to deposit money to earn a high investment benefit. Therefore, allocation of members in a Rosca group becomes very important, and how to allocate members in a Rosca group in an automatic and more efficient way with an effectively controlled risk so as to objectively improve the efficiency of calculating a Rosca group has become a problem confronted by the current network Rosca system in data processing. Accordingly, the “efficient Internet Rosca data processing method” of this application has been devised by the present inventor, which will be briefly described as follows.

### SUMMARY

In view of the foregoing, certain embodiments of the present invention provide an efficient Internet Rosca data processing method, which can achieve automatic calculation of a Rosca group to further improve the data processing efficiency.

According to the concepts of certain embodiments of the present invention, an Internet Rosca data processing method is provided. The Internet Rosca data processing method is executed by a server, wherein the server comprises a logic operation module and a receiving module, a storage module and a setting module that are electrically connected with the logic operation module. The Internet Rosca data processing method in certain embodiments comprises the following steps of:

(A) the receiving module receives from a user terminal a first instruction for a member to join in a Rosca set, wherein the Rosca set comprises a plurality of Rosca groups;

(B) the receiving module transmits the first instruction to the logic operation module, and the logic operation module acquires from the storage module a first Rosca group winning bid period of the member when the member joins in a first Rosca group of the Rosca set;

(C) the logic operation module acquires from the storage module a previous bid of the member in any of the Rosca groups of the Rosca set;

(D) the logic operation module determines a loan benchmark indicator of the member through calculation and comparison according to at least one of the first Rosca group winning bid period and the previous bid, and generates a second instruction; and

(E) the logic operation module transmits the second instruction to the setting module, and the setting module adds the member into a second Rosca group of the Rosca set according to the second instruction.

The present invention also includes an Internet Rosca data processing method. The Internet Rosca data processing method is executed by a server, wherein the server comprises a logic operation module and a receiving module, a storage module and a setting module that are electrically connected with the logic operation module. The Internet Rosca data processing method comprises the following steps of:

(A) the receiving module receives a plurality of first instructions transmitted by a plurality of user terminals so that the logic operation module adds a plurality of members into a Rosca set that comprises a plurality of Rosca groups;

(B) the logic operation module receives the plurality of first instructions, and classifies the plurality of members as loan benchmark members and investment benchmark members according to the plurality of first instructions, account information of the plurality of members stored in the storage module, and winning bid information and bidding information in the first Rosca group of the Rosca set that are stored in the storage module; and

(C) the setting module adds the loan benchmark members and the investment benchmark members into a second Rosca group of the Rosca set according to a predetermined percentage to obtain all members of the second Rosca group.

According to the aforesaid methods, firstly the members are classified as loan benchmark members and investment benchmark members according to account information and history bidding information of the members, which allows for efficient classification of the members in the Rosca group to improve the data processing efficiency. Furthermore, because of the reasonable percentages of the loan benchmark members and the investment benchmark members in the well classified Rosca group, the probability of failed bids is greatly reduced so that repeated computations caused by the failed bids can be significantly reduced to ease the computation load of the server.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of an Internet Rosca system;

FIG. 1B is a block diagram illustrating internal functional blocks of a server;

FIG. 2 is a flowchart diagram of an Internet Rosca data processing method according to a first embodiment;

FIG. 3 is a flowchart diagram of detailed steps of the Internet Rosca data processing method according to a first embodiment; and

FIG. 4 is a flowchart diagram of an Internet Rosca data processing method according to a second embodiment.

### DETAILED DESCRIPTION

In the following description, the present invention will be explained with reference to example embodiments thereof. However, these example embodiments are not intended to limit the present invention to any specific examples, embodiments, environment, applications or particular implementations described in these example embodiments. Therefore, description of these example embodiments is only for purpose of illustration rather than to limit the present invention.

It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

Before referring to the attached drawings of the present invention, similarities and differences between the innovative Internet Rosca system according to the network direct finance method of the present invention and the conventional Rosca will be detailed. The Rosca group adopted in the present invention is to satisfy the needs of members in the group to finance with each other and to decide the right of use of funds by allowing members having the bidding qualification to bid period by period in the group. In the effective duration of a Rosca group, a bid is opened once for each period, and the one who bids at the highest price will win the bid and acquire the bid fund. Because each member has only one chance to win the bid, a member who wins the bid will lose the qualification to bid for future periods while those who fails in the bid still have the qualification to bid for the next period. It shall be further appreciated that, for the first period and the last period, a no-headman mechanism may be adopted for the Rosca group of the present invention, in which case the system takes the responsibility for the Rosca operations and the member breachment duties; thus, it differs from the conventional Rosca where the headman will certainly win the bid in that, each of the members can bid in the first period. For the last period, although nominally a bid can still be made, there is only one bidder left and, therefore, actually no bidding activity exists in the last period.

In terms of the fund payment relationship, the fund of the Rosca group totally comes from mutual financing between the members, so a fund zero sum relationship exists for the fund payment. A member who wins the bid of the current period will be authorized to obtain the fund paid by other members (including those who fail to win and the one who wins the bid). Both the members who fail to win the bid and the winner have the obligation to pay the funds to the winner, and the primary difference therebetween is that, for the members who fail to win the bid, the amount to be paid can be affected by the bidding in the future periods, while the winner has to pay back the fund previously obtained through installments period by period.

For members who fail to win the bid, members who have won a bid and the member who wins the bid of the current period, the way to calculate the receivable funds and the payable funds shall be distinguished between an internal bid mode and an external bid mode. Members who fail to win the bid of the current period include active members and inactive members. The active members refer to members who have not won any bid in the Rosca group, and the inactive members refer to members who have previously won a bid in the Rosca group. The winning bid obtained by the winning member is the sum of contributions actually paid by all unwinning members in the current period including the active members and the inactive members, or is equal to the sum minus a certain service fee.

The bid term is a bid amount. For a Rosca group of the internal bid mode, the contribution actually paid by each active member is equal to the basic contribution minus the bid amount proposed by the winning member, and the contribution actually paid by each inactive member is the basic contribution. For a Rosca group of the external bid mode, the contribution actually paid by each active member is the basic contribution, and the contribution actually paid by each inactive member is the basic contribution plus a bid amount proposed by the inactive member when this inactive member previously won a bid.

The receivable or payable funds for members who fail to win the bid, members who have won a bid and the member who wins the bid of the current period are calculated as follows:

1. An amount receivable by the member who wins the bid of the current period:

(1) the internal bid mode:

Aₙ=(U−Iₙ)×(N−n)+U×(n−1)

(2) the external bid mode:

$${A}_{n} = U \times ( N - n ) + U \times ( n - 1 ) + {\sum }_{i = j}^{n - j} {I}_{i}$$

2. An amount to be paid by members who fail to win the bid:

(1) the internal bid mode: U−In

(2) the external bid mode: U

3. An amount to be paid by each member who has previously won a bid:

(1) the internal bid mode: U

(2) the external bid mode: U+In

where, An represents a total winning bid obtained by the winning member in a n^{th} period;

U represents the basic contribution, which is also the bid upper limit;

N represents the total number of periods of the Rosca group;

n represents the current bid period;

In represents the winning bid of the winning member in the n^{th} period;

Ii represents the winning bid of the i^{th} period in the external bid mode, where i<n.

What described above are only basic formulas for calculating the amounts to be paid, and the system service fees are not taken into account therein.

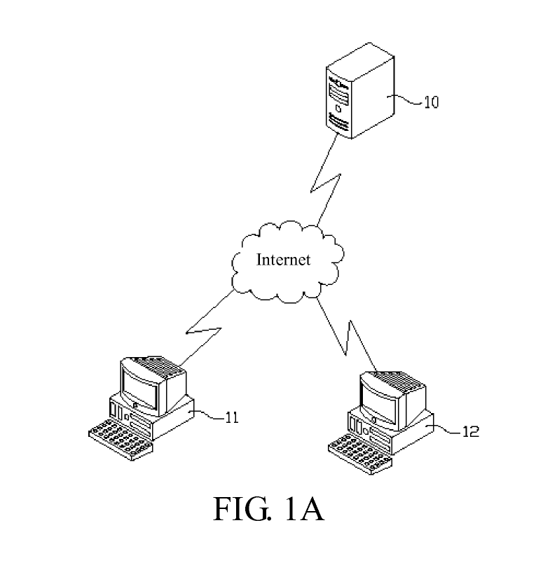

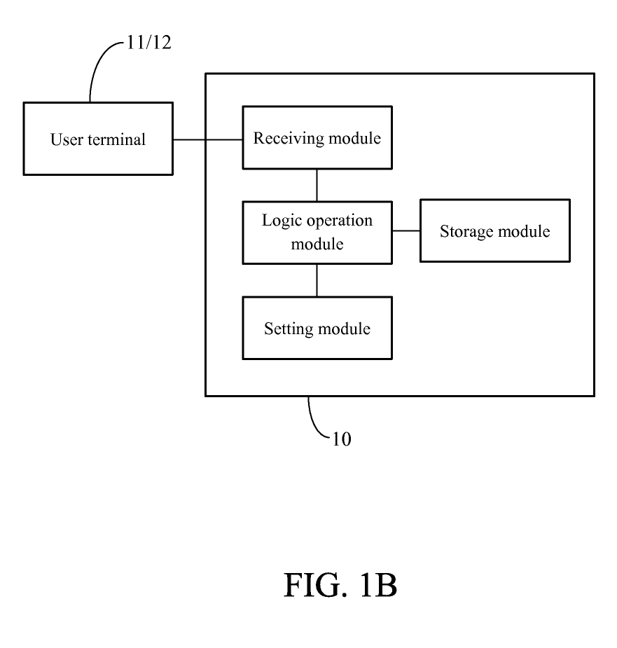

Referring to FIG. 1A, which is a schematic view illustrating an architecture of an Internet Rosca data processing system. As shown in FIG. 1, a user terminal 11 connects with a user terminal 12 via the Internet and an Internet Rosca system 10. The Internet Rosca system 10 may comprise at least one server. It can be appreciated that, although only two user terminals are illustrated in FIG. 1, there may be more or less user terminals. Each user terminal can be used by a different member to log in the Internet Rosca system.

Referring to FIG. 1B, the server 10 comprises a receiving module, a storage module, a logic operation module and a setting module, and the logic operation module is electrically connected with the receiving module, the storage module and the setting module respectively. The receiving module is a network interface, a network transceiver, a Universal Serial Bus (USB) interface, or some other interface for receiving an instruction from a user. The storage module is a module having a data storage function such as a hard disk, a database or the like. The logic operation module is a microprocessor or a comparison circuit. The setting module is also a microprocessor.

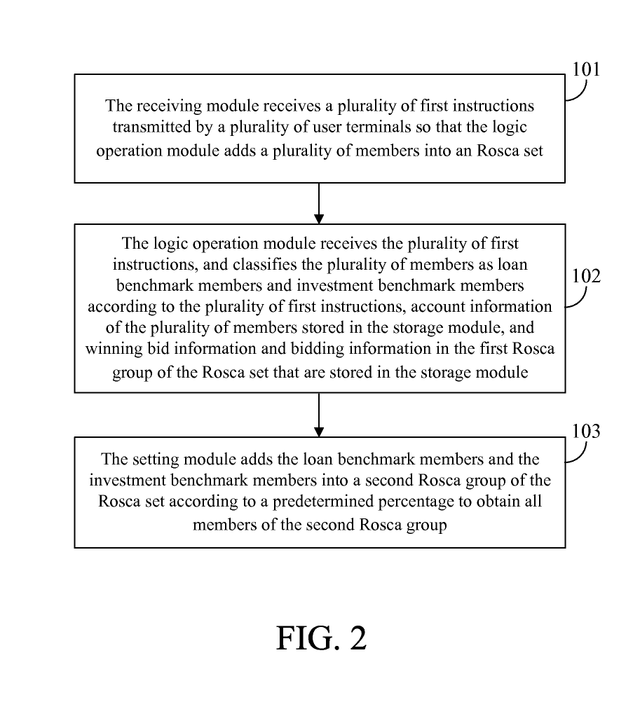

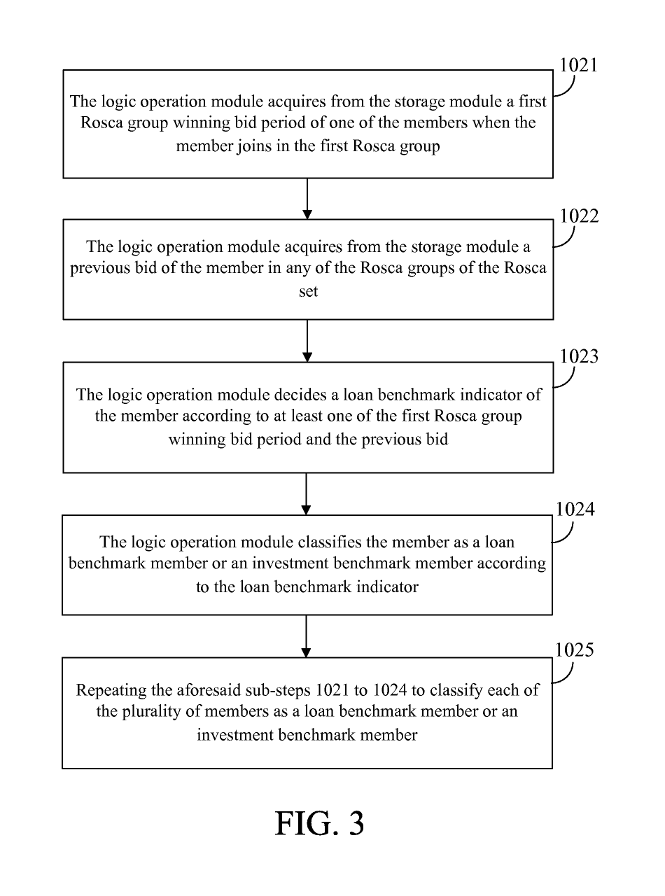

Referring to FIG. 2 and FIG. 3, there are shown flowchart diagrams of an efficient Internet Rosca data processing method according to a first embodiment of the present invention. The method of this embodiment may be executed by the server of the Internet Rosca system shown in FIG. 1A and FIG. 1B as well as functional modules thereof.

As shown in FIG. 2, the method of this embodiment comprises the following steps.

Step 101: the receiving module receives a plurality of first instructions transmitted by a plurality of user terminals so that the logic operation module adds a plurality of members into a Rosca set that comprises a plurality of Rosca groups.

Referring to FIG. 1A and FIG. 1B, a member logs in the Internet Rosca system 10 via the user terminal 11 or 12 to carry out various operations, e.g., applying to join in the Internet Rosca, depositing a fund, transferring a fund and so on. The storage module may comprise the following information therein: a set of all the Rosca groups and information of all members who have joined in the Rosca groups:

Step 102: the logic operation module receives the plurality of first instructions, and classifies the plurality of members as loan benchmark members and investment benchmark members according to the plurality of first instructions, account information of the plurality of members stored in the storage module, and winning bid information and bidding information in the first Rosca group of the Rosca set that are stored in the storage module.

The account information of the members refers to, for example, various pieces of credit information of the members. Through a credit investigation procedure, a member can obtain a guarantee credit immediately when he or she joins in the Rosca set, and then as the member deposits an actually paid contribution in each period of any of the Rosca group in the Rosca set, the member can obtain a corresponding self-accumulated credit. Then, the sum of the guarantee credit and the self-accumulated credit is just the total credit that the member currently has.

The self-accumulated credit is equal to a debt amount subtracted from a creditor's right amount of the member in the Rosca set. The creditor's right amount is a right amount of the member in all unwinning Rosca groups among all the Rosca groups that the member joins in the Rosca set, and is calculated according to the following formula:

creditor's right amount=(the number of periods that have been completed in all the unwinning Rosca groups among all the Rosca groups that the member joins in the Internet Rosca system)*basic contribution.

The debt amount of the member is an amount to be paid in all winning Rosca groups among all the Rosca groups that the member joins in the Rosca set, and is calculated according to the following formula:

debt amount=(the number of remaining periods in all winning Rosca groups among all the Rosca group that the member joins in the Internet Rosca system)*(contribution actually paid);

Wherein, the contribution actually paid is an amount actually paid by each member in each period, and is one of the basic contribution, the basic contribution plus a bid, and the basic contribution minus the bid.

The aforesaid winning bid information may comprise, for example, the winning period and the winning bid in any of the Rosca groups in the Rosca set. The aforesaid bidding information may comprise, for example, the bidding period and the bid in any of the Rosca groups in the Rosca set.

Additionally, whether a member is a loan benchmark member may be determined by observing use of the guarantee credit by the member. In the conventional way to calculate the loan benchmark, although the level of demand of a member for the fund in a specific Rosca group can be determined, the level of demand cannot completely represent whether the member has a loan demand because although a member has a very high won bid time ratio or a very high bid rate, he or she does not use the guarantee credit and, instead, only uses the self-accumulated credit to bid. Then strictly speaking, the member does not has a loan behavior, so the behavior of using the guarantee credit may be used as an additional indicator to determine whether the member is a loan benchmark member. For example, the usage amount and percentage of the guarantee credit may be used to determine whether the member is a loan benchmark member more exactly.

1. Accumulated usage amount of the guarantee credit: refers to the total accumulated usage amount of the member so far.

2. Usage amount of the guarantee credit: an amount of the guarantee credit that is used within a certain period.

3. Percentage of the usage amount of the guarantee credit to the total amount of the guarantee credit (usage rate of the guarantee credit): (Usage amount of the guarantee credit)/(Total amount of the guarantee credit).

In an implementation, as shown in FIG. 3, the step 102 comprises the following sub-steps:
Sub-step 1021: the logic operation module acquires from the storage module a first Rosca group winning bid period of one of the members when the member joins in the first Rosca group.
Sub-step 1022: the logic operation module acquires from the storage module a previous bid of the member in any of the Rosca groups of the Rosca set.
Sub-step 1023: the logic operation module decides a loan benchmark indicator of the member according to at least one of the first Rosca group winning bid period and the previous bid.
For example, in the sub-step 1023, a previous won bid time ratio is calculated to be Tr=(N1−x)/N1;
a previous bidding interest rate ratio is calculated to be Br=(Ij/Uj)/Brt; and
the loan benchmark indicator is calculated to be Ai=Tr*w1+Br*w2,

Wherein, Tr is the previous won bid time ratio, N1 is a total number of bidding periods of the first Rosca group, x is No. of the winning bid period of the member in the first Rosca group, Br is the previous bidding interest rate ratio, Ij is a previous bid of the member, Uj is a basic contribution corresponding to the previous bid of the member, Brt is a predetermined interest rate upper limit, w1 is a first predetermined weight factor, and w2 is a second predetermined weight factor.
Sub-step 1024: the logic operation module classifies the member as a loan benchmark member or an investment benchmark member according to the loan benchmark indicator.
Sub-step 1025: repeating the aforesaid sub-steps 1021 to 1024 to classify each of the plurality of members as a loan benchmark member or an investment benchmark member.

For example, in one implementation, the sub-step 1024 comprises: the logic operation module compares the loan benchmark indicator with a predetermined indicator threshold, and if the loan benchmark indicator is greater than the indicator threshold, then the logic operation module determines that the member is a loan benchmark member, and if the loan benchmark indicator is smaller than the indicator threshold, then the logic operation module determines that the member is an investment benchmark member.

In another implementation, the sub-step 1024 comprises: the logic operation module compares the loan benchmark indicator with a predetermined indicator threshold, and compares a total credit of the member with a group fund scale of the second Rosca group, and if the loan benchmark indicator is greater than the indicator threshold and the total credit is greater than the group fund scale, then the logic operation module determines that the member is a loan benchmark member and, otherwise, determines that the member is an investment benchmark member, wherein the group fund scale is a product of the basic contribution and (the number of periods of the second Rosca group−1).

Then, the logic operation module generates a second instruction according to a classification result of the step 102, and transmits the second instruction to the setting module. Then, a step 103 of the Internet Rosca data processing method is executed as follows: the setting module adds the loan benchmark members and the investment benchmark members into a second Rosca group of the Rosca set according to a predetermined percentage to obtain all members of the second Rosca group.

In a particular implementation, the predetermined percentage is that the number of the loan benchmark members to the number of the investment benchmark members is 1:2.

According to the aforesaid methods, firstly the members are classified as loan benchmark members and investment benchmark members according to account information and history bidding information of the members, which allows for efficient classification of the members in the Rosca group to improve the data processing efficiency. Furthermore, because of the reasonable percentages of the loan benchmark members and the investment benchmark members in the well classified Rosca group, the probability of failed bids is greatly reduced so that repeated computations caused by the failed bids can be significantly reduced to ease the computation load of the server.

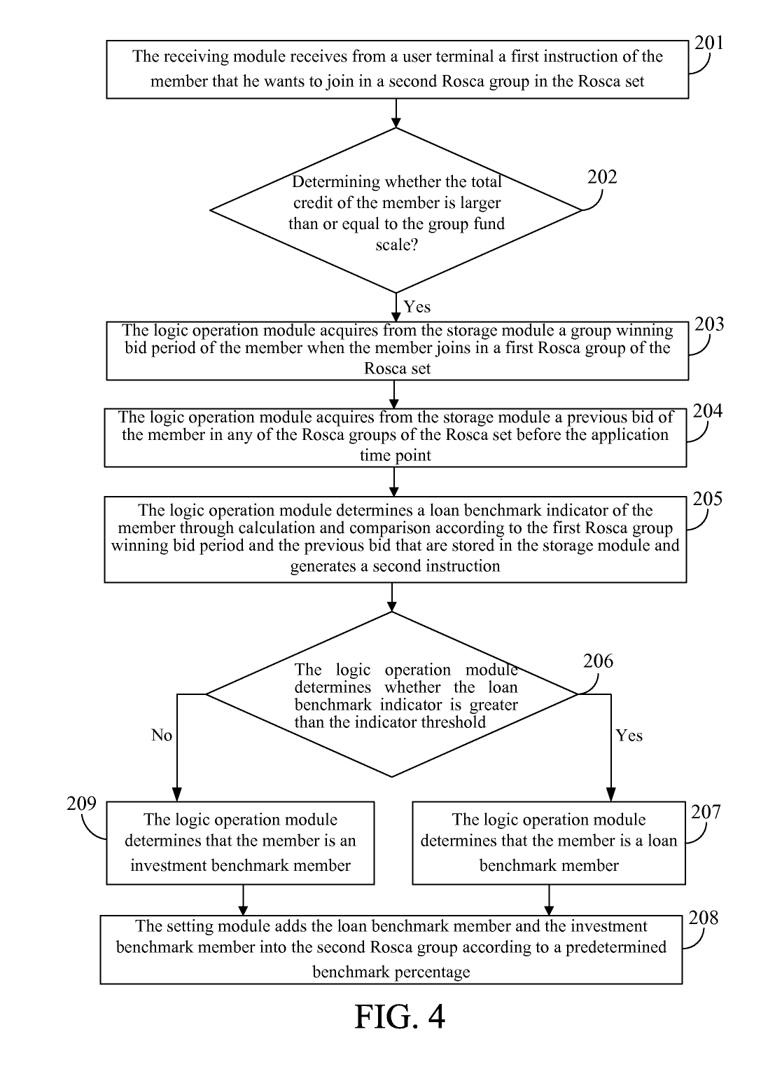

Referring to FIG. 1A, FIG. 1B and FIG. 4 together, FIG. 4 is a schematic flowchart diagram of a second embodiment of the Internet Rosca data processing method according to the present invention. This embodiment mainly describes how the server classifies a single member. In FIG. 1A and FIG. 1B, a member logs in an Internet Rosca system via a user terminal. The system comprises a server 10, and the server 10 comprises a logic operation module as well as a receiving module, a storage module and a setting module electrically connected with the logic operation module. The receiving module receives a first instruction for a member to join in a Rosca set which comprises a plurality of Rosca groups.

Through a credit investigation procedure, the member can obtain a guarantee credit immediately when he or she joins in the Rosca set, and then as the member deposits an actually paid contribution in each period of any of the Rosca group in the Rosca set, the member can obtain a corresponding self-accumulated credit. Then, the sum of the guarantee credit and the self-accumulated credit is just the total credit that the member currently has.

The self-accumulated credit is equal to a debt amount subtracted from a creditor's right amount of the member in the Rosca set. The creditor's right amount is a right amount of the member in all unwinning Rosca groups among all the Rosca groups that the member joins in the Rosca set, and is calculated according to the following formula:

creditor's right amount=(the number of periods that have been completed in all the unwinning Rosca groups among all the Rosca groups that the member joins in the Internet Rosca system)*basic contribution.

The debt amount of the member is an amount to be paid in all winning Rosca groups among all the Rosca groups that the member joins in the Rosca set, and is calculated according to the following formula:

debt amount=(the number of remaining periods in all winning Rosca groups among all the Rosca group that the member joins in the Internet Rosca system)*(contribution actually paid);

Wherein, the contribution actually paid is an amount actually paid by each member in each period, and is one of the basic contribution, the basic contribution plus a bid, and the basic contribution minus the bid.

In addition to determination of the self-accumulated credit, the guarantee credit is also determined in this system because although the level of demand of a member for the fund in a specific Rosca group can be determined, the level of demand cannot completely represent whether the member has a loan demand. The reason lies in that: although a member has a very high won bid time ratio or a very high bid rate, he or she does not use the guarantee credit and, instead, only uses the self-accumulated credit to bid. Then strictly speaking, the member does not has a loan behavior, so the behavior of using the guarantee credit may be used as an additional indicator to determine whether the member is a loan benchmark member.

Firstly, the receiving module of the server receives from a user terminal a first instruction of the member that he wants to join in a second Rosca group in the Rosca set (step 201). Then, the receiving module of the server transmits the first instruction to the logic operation module, and the logic operation module compares a total credit of the member that is stored in the storage module with a group fund scale of the second Rosca group to determine whether the total credit of the member is larger than or equal to the group fund scale (step 202). If the total credit of the member is smaller than the group fund scale of the second Rosca group, then the logic operation module of the server determines that the member is an investment benchmark member (step 209).

If the total credit of the member is larger than or equal to the group fund scale of the second Rosca group, then the logic operation module acquires from the storage module a group winning bid period of the member when the member joins in a first Rosca group of the Rosca set (step 203), and the logic operation module acquires from the storage module a previous bid of the member in any of the Rosca groups of the Rosca set before the application time point (step 204). Next, the logic operation module determines a loan benchmark indicator of the member through calculation and comparison according to the first Rosca group winning bid period and the previous bid that are stored in the storage module and generates a second instruction (step 205). Here, the loan benchmark indicator is decided according to the following formulas:

Ai=Tr*w1+Br*w2 (f1)

Tr=(N1−x)/N1 (f2)

Br=(Ij/Uj)/Brt (f3)

Wherein, Ai is the loan benchmark indicator, Tr is a previous won bid time ratio, N1 is a total number of bidding periods of the first Rosca group, x is No. of the winning bid period of the member in the first Rosca group, Br is the previous bidding interest rate ratio, Ij is the previous bid of the member, Uj is a basic contribution corresponding to the previous bid of the member, Brt is a predetermined interest rate ratio upper limit, w1 is a first predetermined weight factor, and w2 is a second predetermined weight factor.

As an example, if the total number of periods in which a person A joins in the first Rosca group is 16, the period in which the person A wins the bid in the first Rosca group is the 4th period, then according to the aforesaid formula (f2), the previous won bid time ratio for the person A is Tr=(N1−x)/N1=(16−4)/16=0.75. The earlier the person wins the bid, the closer the Tr value is to 1.

As another example, if the total number of periods in which the person A joins in a fifth Rosca group of the Rosca set is 12, the basic contribution is 10,000 Yuan, the 6^{th} period just begins, the person A bids 500 Yuan this time, and the predetermined interest rate ratio upper limit Brt is 10%, then according to the aforesaid formula (f3), the previous bidding interest rate ratio is Br=(Ij/Uⱼ)/Brt=500/10000/0.1=0.5.

As yet another example, if the first predetermined weight factor w1=0.4, the second predetermined weight factor w2=0.6, then according to the aforesaid formula (f1), the loan benchmark indicator of the person A is Ai=Tr*w1+Br*w2=0.75*0.4+0.5*0.6=0.3+0.3=0.6.

Then, the logic operation module compares the loan benchmark indicator with a predetermined indicator threshold to determine whether the loan benchmark indicator is greater than the indicator threshold (step 206). If the loan benchmark indicator is greater than or equal to the indicator threshold, then the logic operation module determines that the member is a loan benchmark member (step 207); and if the loan benchmark indicator is smaller than the indicator threshold, then the logic operation module determines that the member is an investment benchmark member (step 209). Here, the indicator threshold may be adjusted according to the practical demands for funds in the market. For example, if there is a stronger practical demand for funds in the market, then the indicator threshold may be adjusted to be higher to reduce the number of members that will be determined as the loan benchmark member.

For example, if the indicator threshold is preset to be 0.25, then the person A will be determined as a loan benchmark member by the logic operation module of the server because the loan benchmark indicator of the person A is 0.6 which is greater than 0.25.

Then, the logic operation module of the server generates the second instruction according to the aforesaid comparison result and transmits the second instruction to the setting module so that the setting module adds the loan benchmark member and the investment benchmark member into the second Rosca group according to a specific percentage (step 208). For example, if the benchmark ratio is: investment benchmark members/loan benchmark members=2/1, then in the second Rosca group which has 12 periods in total (i.e., 12 members are needed), the number of the loan benchmark members is 4 and the number of the investment benchmark members is 8.

In general financial services, the loan amount, the interest rate and the life of loan are given by the bank according to the credit rating or the collaterals, and the members can only passively accept the conditions proposed by the bank. The loan benchmark indicator consists of the bid of the member and the period in which the member wins the bid (an earlier period in which the member wins the bid represents a higher demand for funds), and exactly represents the level of the member's demand for funds. With this information, the platform can provide other financial products to the members according to the members' demands for funds so as to satisfy the members' financial demands and also to give an alarm of the risk of the members' funds.

The most prominent shortcomings of the conventional Rosca lie in that: firstly, the number of participants is limited; and secondly, if there is nobody to bid in a period, then the members will be forced to draw lots to get a loan at an interest rate. In contrast, with the loan benchmark indictor, the platform can averagely allocate those who have demands for funds and those who want to deposit money for investment in each Rosca group so that the problems of inefficient grouping and inefficient bidding of the conventional Rosca can be well solved.

As can be known from the above descriptions, the Internet Rosca data processing method of the present invention provides an objective standard of evaluating the user's loan benchmarks. This can optimize the allocation process of the Rosca groups, reduce the calculation errors possibly generated in the allocation process, and improve the efficiency of allocating members in the Rosca groups so that those who have demands for funds and those who provide funds can be properly allocated in real time and automatically in the Rosca groups. Thereby, the utilization efficiency of the funds in the Rosca groups can be improved and the willingness of the users to participate can be enhanced. Accordingly, the present invention surely provides an innovative design and is hereby filed for application.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An Internet Rosca (Rotating Savings and Credit Association) data processing method executed by a server, wherein the server comprises a logic operation module and a receiving module, a storage module and a setting module that are electrically connected with the logic operation module, the Internet Rosca data processing method comprising:
(A) the receiving module receiving from a user terminal a first instruction for a member to join in a Rosca set, wherein the Rosca set comprises a plurality of Rosca groups;
(B) the receiving module transmitting the first instruction to the logic operation module, and the logic operation module acquiring from the storage module a first Rosca group winning bid period of the member when the member joins in a first Rosca group of the Rosca set;
(C) the logic operation module acquiring from the storage module a previous bid of the member in any of the Rosca groups of the Rosca set;
(D) the logic operation module determining a loan benchmark indicator of the member through calculation and comparison according to at least one of the first Rosca group winning bid period and the previous bid, and generates a second instruction; and
(E) the logic operation module transmitting the second instruction to the setting module, and the setting module adds the member into a second Rosca group of the Rosca set according to the second instruction.

2. The method as claimed in claim 1, wherein the step (D) further comprises:
(D1) the logic operation module deciding a previous won bid time ratio to be Tr=(N1−x)/N1;
(D2) the logic operation module deciding a previous bidding interest rate ratio to be Br=(Ij/Uj)/Brt; and
(D3) the logic operation module deciding the loan benchmark indicator to be Ai=Tr*w1+Br*w2,
where, Tr is the previous won bid time ratio, N1 is a total number of bidding periods of the first Rosca group, x is No. of a winning bid period of the member in the first Rosca group, Br is the previous bidding interest rate ratio, Ij is the previous bid of the member, Uj is a basic contribution corresponding to the previous bid of the member, Brt is a predetermined interest rate upper limit, w1 is a first predetermined weight factor, and w2 is a second predetermined weight factor.

3. The method as claimed in claim 2, wherein the step (D) further comprises:
(E1) the logic operation module comparing the loan benchmark indicator with a predetermined indicator threshold, and if the loan benchmark indicator is greater than the indicator threshold, then the logic operation module determines that the member is a loan benchmark member, and if the loan benchmark indicator is smaller than the indicator threshold, then the logic operation module determines that the member is an investment benchmark member; and
(E2) the setting module adding the loan benchmark member and the investment benchmark member into the second Rosca group according to a specific percentage.

4. The method as claimed in claim 2, wherein the step (E) further comprises: the logic operation module determining whether the member is allowed to join in the second Rosca group according to a total credit of the member, wherein the total credit is a sum of a guarantee credit and a self-accumulated credit of the member, the self-accumulated credit is equal to a debt amount subtracted from a creditor's right amount of the member in the Rosca set, the creditor's right amount is a right amount of the member in all unwinning Rosca groups among all the Rosca groups that the member joins in the Rosca set, and the creditor's right amount being calculated according to the following formula:
creditor's right amount=(the number of periods that have been completed in all the unwinning Rosca groups among all the Rosca groups that the member joins in an Internet Rosca system)*the basic contribution;
the debt amount of the member is an amount to be paid in all winning Rosca groups among all the Rosca groups that the member joins in the Rosca set, and is calculated according to the following formula:
debt amount=(the number of remaining periods in all winning Rosca groups among all the Rosca group that the member joins in the Internet Rosca system)*(contribution actually paid);
where, the contribution actually paid is an amount actually paid by each member in each period, and is one of the basic contribution, the basic contribution plus a bid, and the basic contribution minus the bid.

5. The method as claimed in claim 4, wherein the step (E) further comprises:
(E3) the logic operation module to comparing the loan benchmark indicator with an indicator threshold, and compares the total credit of the member with a group fund scale of the second Rosca group, and if the loan benchmark indicator is greater than the indicator threshold and the total credit is greater than the group fund scale, then the logic operation module determining that the member is a loan benchmark member and, otherwise, determining that the member is an investment benchmark member, wherein the group fund scale is a product of the basic contribution and (the number of periods of the second Rosca group−1); and
(E4) the setting module adding loan benchmark members and investment benchmark members into the second Rosca group according to a specific percentage.

6. The method as claimed in claim 3, wherein the specific percentage is that the number of the loan benchmark members to the number of the investment benchmark members is 1:2.

7. The method as claimed in claim 5, wherein the specific percentage is that the number of the loan benchmark members to the number of the investment benchmark members is 1:2.

8. An Internet Rosca data processing method executed by a server, the server comprising a logic operation module and a receiving module, a storage module and a setting module that are electrically connected with the logic operation module, the Internet Rosca data processing method comprising:
(A) the receiving module receiving a plurality of first instructions transmitted by a plurality of user terminals so that the logic operation module adds a plurality of members into an Rosca set that comprises a plurality of Rosca groups;
(B) the logic operation module receiving the plurality of first instructions, and classifiying the plurality of members as loan benchmark members and investment benchmark members according to the plurality of first instructions, account information of the plurality of members stored in the storage module, and winning bid information and bidding information in the first Rosca group of the Rosca set that are stored in the storage module; and
(C) the setting module adding the loan benchmark members and the investment benchmark members into a second Rosca group of the Rosca set according to a predetermined percentage to obtain all members of the second Rosca group.

9. The method as claimed in claim 8, wherein the step (B) further comprises:
(B1) the logic operation module acquiring from the storage module a first Rosca group winning bid period of one of the members when the member joins in the first Rosca group;
(B2) the logic operation module acquiring from the storage module a previous bid of the member in any of the Rosca groups of the Rosca set;
(B3) the logic operation module deciding, from the storage module, a loan benchmark indicator of the member according to at least one of the first Rosca group winning bid period and the previous bid;
(B4) the logic operation module classifying the member as a loan benchmark member or an investment benchmark member according to the loan benchmark indicator; and
(B5) repeating the aforesaid steps (B1) to (B4) to classify each of the plurality of members as a loan benchmark member or an investment benchmark member.

10. The method as claimed in claim 9, wherein the step (B4) comprises:
(B41) the logic operation module calculating a previous won bid time ratio to be Tr=(N1−x)/N1;
(B42) the logic operation module calculating a previous bidding interest rate ratio to be Br=(Ij/Uj)/Brt; and
(B43) the logic operation module calculating the loan benchmark indicator to be Ai=Tr*w1+Br*w2,
where, Tr is the previous won bid time ratio, N1 is a total number of bidding periods of the first Rosca group, x is No. of a winning bid period of the member in the first Rosca group, Br is the previous bidding interest rate ratio, Ij is a previous bid of the member, Uj is a basic contribution corresponding to the previous bid of the member, Brt is a predetermined interest rate upper limit, w1 is a first predetermined weight factor, and w2 is a second predetermined weight factor.

11. The method as claimed in claim 10, wherein the step (B4) further comprises:
(B44) the logic operation module comparing the loan benchmark indicator with a predetermined indicator threshold, and if the loan benchmark indicator is greater than the indicator threshold, then the logic operation module determining that the member is a loan benchmark member, and if the loan benchmark indicator is smaller than the indicator threshold, then the logic operation module determining that the member is an investment benchmark member.

12. The method as claimed in claim 9, wherein the step (B4) further comprises:
(B45) the logic operation module comparing the loan benchmark indicator with a predetermined indicator threshold, and comparing a total credit of the member with a group fund scale of the second Rosca group, and if the loan benchmark indicator is greater than the indicator threshold and the total credit is greater than the group fund scale, then the logic operation module determining that the member is a loan benchmark member and, otherwise, determining that the member is an investment benchmark member, wherein the group fund scale is a product of the basic contribution and (the number of periods of the second Rosca group−1).
